(19) United States
(12) Patent Application Publication
(10) Pub. No.: US 2002/0015605 A1
(43) Pub. Date: Feb. 7, 2002

(54) Delivery device to be externally fitted to image forming apparatus

(75) Inventor: Mitsuhiko Otaki, Yokohama-shi (JP)

Correspondence Address: FRISHAUF, HOLTZ, GOODMAN &, LANGER & CHICK, PC, 767 THIRD AVENUE, 25TH FLOOR, NEW YORK, NY, 10017-2023, US

(73) Assignee: Toshiba Tac Kabushiki Kaisha, Tokyo (JP)

(21) Appl. No.: 09/911,655

(22) Filed: Jul. 24, 2001

(30) Foreign Application Priority Data
Jul. 28, 2000 (JP) 2000-229317

(51) Int. Cl. G03G 15/00

(52) U.S. Cl. 399/405

(57) ABSTRACT

A delivery device comprises a frame to be fitted to the main body of an image forming apparatus carrying an image recording mechanism mounted therein and provided with a delivery port and a delivery mechanism for delivering sheets of recording paper along a delivery route to the outside through the delivery port, a sheet delivery mechanism arranged in the frame for sending out the sheets of recording paper discharged from the delivery port of the main body in a predetermined direction, a sheet detection sensor arranged along the sheet transfer path in the main body for detecting a sheet of recording paper and a delivery drive directing circuit for directing the sheet delivery mechanism to be driven on the basis of the detection output of the sheet detection sensor. The delivery drive directing circuit is arranged in the main body.

### CROSS-REFERENCE TO RELATED APPLICATIONS

This application is based upon and claims the benefit of priority from the prior Japanese Patent Application No. 2000-229317, filed Jul. 28, 2000, the entire contents of which are incorporated herein by reference.

### BACKGROUND OF THE INVENTION

1. Field of the Invention

This invention relates to a delivery device to be externally fitted to an image forming apparatus.

2. Description of the Related Art

Some image forming apparatuses comprising an image recording mechanism employing electrophotography and are adapted to be used as a copying machine, facsimile machine or printer are designed to deliver sheets of recording paper carrying images that have been recorded into a delivery space arranged within the image forming apparatus main body and, hence, such apparatuses are referred to as an intra-cylinder delivery type apparatus.

Intra-cylinder delivery type image forming apparatuses are normally provided with a delivery device as an optional unit arranged vis-a-vis the delivery port that is arranged in turn vis-a-vis the delivery space in the image forming apparatus main body and designed to deliver sheets of recording paper in a manner different from the standard delivery operation of delivery sheets of recording paper from the delivery port to the delivery space along the predetermined delivery route. The delivery device may comprise a sheet delivery mechanism such as a transversal delivery mechanism that typically receives the sheets of recording paper discharged from the delivery port of the image forming apparatus main body and transfers them in a direction perpendicular (offset) relative to the delivery route or a sorting/delivery mechanism adapted to sort the sheets of recording paper discharged from the delivery port into two groups and put them in two vertically arranged respective trays.

Conventionally, the delivery device to be fitted to an image forming apparatus as an optional unit is provided in the frame thereof with a drive sensor for detecting the sheet of recording paper being transferred along the recording paper delivery route in the delivery device and outputting a detection signal and a delivery drive directing circuit for outputting a drive directing signal to the transversal feeding mechanism or the sorting/feeding mechanism upon receiving the signal output from the drive sensor as a trigger signal so that the sheet delivery mechanism may be driven to operate upon receiving a sheet of recording paper discharged from the delivery port of the image forming apparatus main body.

As pointed out above, the delivery device is provided in the frame thereof with a drive sensor for detecting the sheet of recording paper being transferred along the recording paper delivery route in the delivery device and outputting a detection signal. In other words, the frame of the delivery device needs to have a space for arranging the drive sensor inside and a holding member for holding the drive sensor which increases the number of components of the image forming apparatus main body and makes the apparatus bulky and costly. Therefore, there may arise a space problem when mounting the delivery device on the image forming apparatus. The means for mounting the delivery device on the image forming apparatus can also become a problem. Additionally, the delivery drive directing circuit for outputting a drive directing signal to the transversal feeding mechanism or the sorting/feeding mechanism upon receiving the signal output from the drive sensor as trigger signal that is arranged in the frame of the delivery device can also make the device bulky.

In view of the above identified circumstances, it is therefore the object of the present invention to provide a delivery device to be externally fitted to an image forming apparatus that comprises a reduced number of components and hence has a compact frame for housing them.

### BRIEF SUMMARY OF THE INVENTION

According to the invention, the above object is achieved by providing a delivery device comprising:

a frame to be fitted to the main body of an image forming apparatus carrying an image recording mechanism mounted therein and provided with a delivery port and a delivery mechanism for delivering sheets of recording paper along a delivery route to the outside through the delivery port;

a sheet delivery mechanism arranged in the frame for sending out the sheets of recording paper discharged from the delivery port of the main body of the image forming apparatus in a predetermined direction;

a sheet detection sensor arranged along the sheet transfer path in the main body of the image forming apparatus for detecting a sheet of recording paper; and

a delivery drive directing circuit for directing the sheet delivery mechanism to be driven on the basis of the detection output of the sheet detection sensor.

Thus, according to the invention, the sheet detection sensor arranged in the main body of the image forming apparatus for detecting a sheet of recording paper can be used as a drive sensor for driving the sheet delivery mechanism by combining the sheet detecting sensor arranged in the main body of the image forming apparatus and the delivery drive directing circuit for directing the sheet delivery mechanism to be driven on the basis of the signal output from the sheet detecting sensor. With such an arrangement, it is no longer necessary to provide the frame of the delivery device with a drive sensor and hence a delivery device according to the invention comprises a reduced number of components and hence has a compact frame for housing them.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the embodiments given below, serve to explain the principles of the invention.

FIG. 1 is a schematic illustration of an image forming apparatus provided with an embodiment of delivery device according to the invention;

FIG. 2 is a schematic illustration of the embodiment of the delivery device of FIG. 1;

FIG. 3 is a schematic block diagram of the electric circuits arranged at the periphery of the control circuit of the embodiment of FIG. 1; and

FIGS. 4A through 4D are timing charts for the operation of the embodiment of the delivery device of FIG. 1.

### DETAILED DESCRIPTION OF THE INVENTION

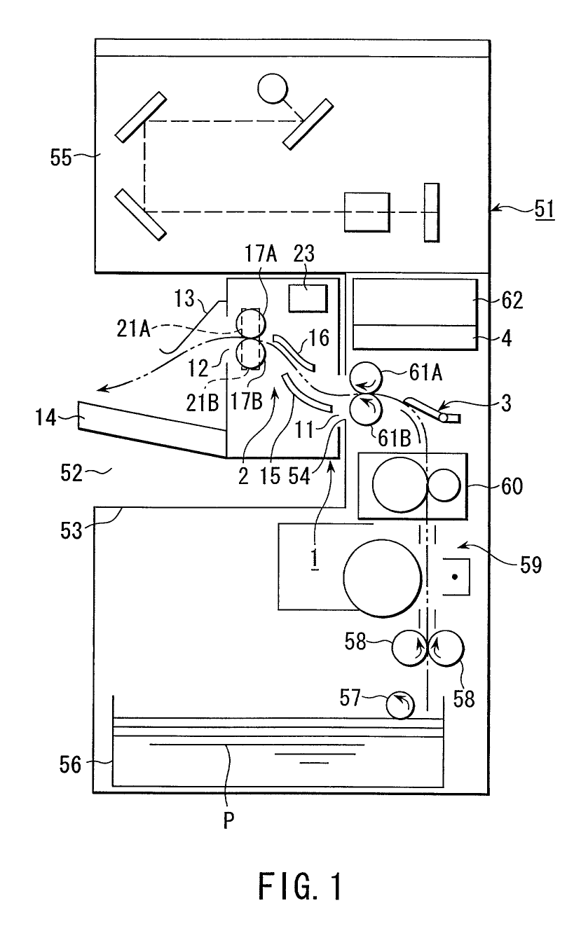

Now, a preferred embodiment of the invention will be described in detail by referring to FIGS. 1 through 3.

This embodiment of the delivery device comprises a transversal feeding mechanism adapted to receive the sheets of recording paper discharged from the delivery port of the image forming apparatus main body and transfer them in a direction perpendicular relative to the ordinary delivery route. FIG. 1 is a schematic illustration of an image forming apparatus provided with this embodiment of delivery device according to the invention.

The image forming apparatus of FIG. 1 is applicable to a copying machine, a facsimile machine or a printer and of the intra-cylinder type designed to deliver sheets of recording paper carrying images that have been recorded into a delivery space arranged in the middle stage of the image forming apparatus main body. Referring to FIG. 1, the image forming apparatus comprises a main body 51 that contains a delivery space 52 arranged in the middle stage of the apparatus main body 51 and occupies half of the floor area of the apparatus main body 51. The delivery space 52 is open to three lateral sides thereof and provided with a delivery tray 53 at the bottom thereof. The only wall of the image forming apparatus main body 51 arranged in the middle stage thereof and defining the single closed side of the delivery space 52 is provided with a horizontally extending delivery port 54 through which sheets of recording paper are discharged.

In the image forming apparatus main body 51, an original reading mechanism 55 is arranged in the top stage and a cassette 56 containing a stack of sheets of recording paper P is provided in the bottom stage. The bottom stage of the image forming apparatus main body 51 is provided with a feed roller 57 for feeding a sheet of recording paper P one at a time from the cassette 56, a transfer roller 58 for transferring the supplied sheet of recording paper P vertically upward and an image forming mechanism 59 for recording an image on the sheet of recording paper P by electrophotography in response to the video signal from the original reading mechanism 55. The middle stage of the image forming apparatus main body 51 is provided with a fixing mechanism 60 for upwardly transferring the sheet of recording paper P that is carrying an image and fixing the image and a pair of delivery rollers 61A, 61B (a typical delivery mechanism) arranged vertically vis-a-vis the delivery port 54 above the fixing mechanism 60 in the image forming apparatus main body 51 so as to deliver the sheet of recording paper P that is carrying the fixed image into the delivery space 52. Thus, after vertically passing through the fixing mechanism 60, the sheet of recording paper P fed from the cassette 56 is guided to turn rectangularly by a guide means (not shown) arranged in the image forming apparatus main body 51 and then made to horizontally pass through the delivery rollers 61A, 61B.

A delivery device according to the invention is adapted to be arranged vis-a-vis the wall defining the delivery space 53 at a position outside the wall and removably fitted to the wall. In this embodiment, the sheet of recording paper P discharged through the delivery port 54 of the image forming apparatus main body 51 is subjected to a processing operation of determining if it is delivered along the delivery route or in a direction perpendicular to the delivery route.

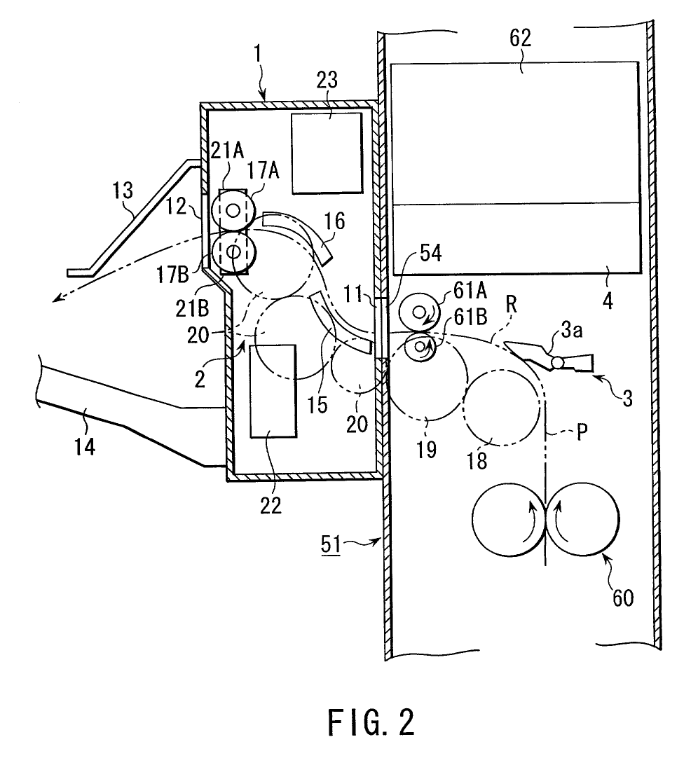

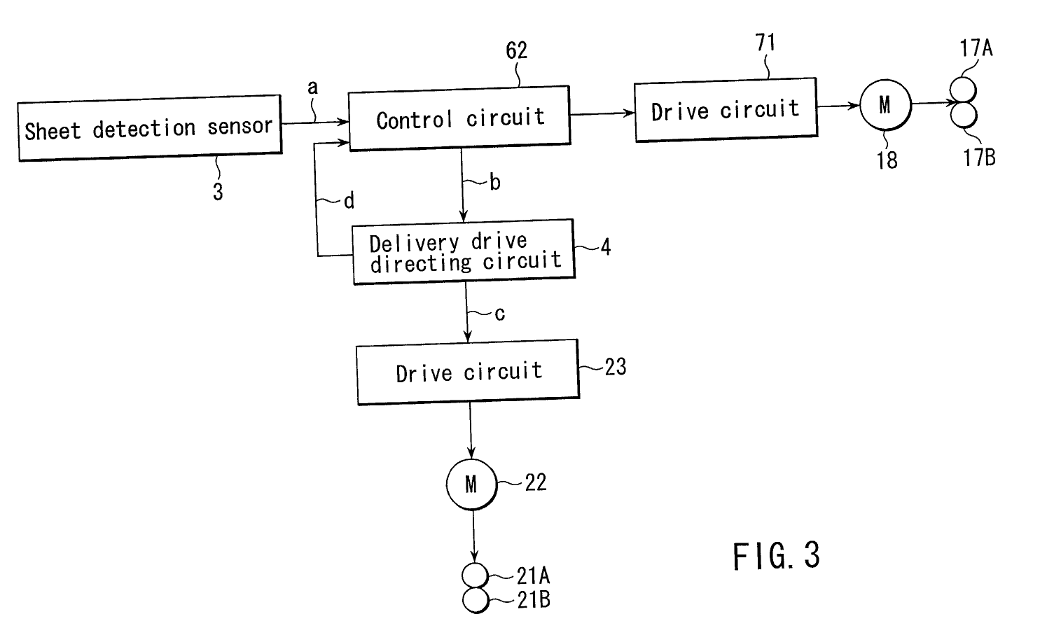

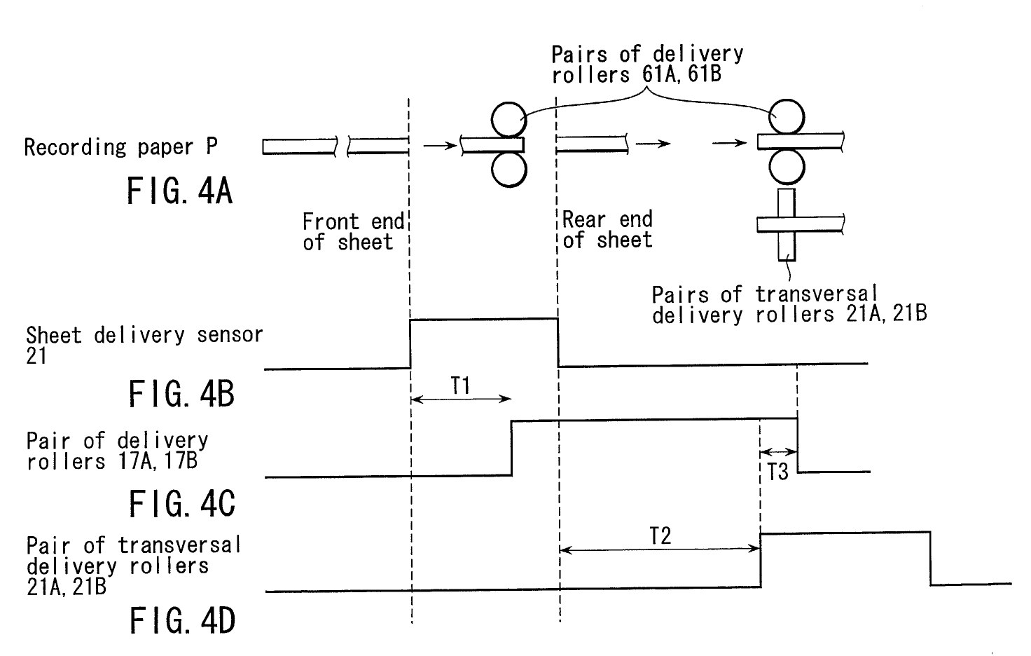

Now, the embodiment of the delivery device according to the invention will described further by referring also to FIGS. 2 and 3. FIG. 2 is a schematic illustration of the embodiment of the delivery device of FIG. 1 and FIG. 3 is a schematic block diagram of the electric circuits arranged at the periphery of the control circuit of the embodiment of FIG. 1, whereas FIGS. 4A through 4D are timing charts for the operation of the embodiment of the delivery device of FIG. 1.

A delivery device according to the invention comprises a frame 1 to be fitted to the main body of an image forming apparatus, a sheet delivery mechanism 2 arranged in the frame 1 and adapted to receive the sheet of recording paper P discharged from the delivery port 54 of the image forming apparatus main body 51 and transfer it in a predetermined direction, a recording paper detection sensor (sheet detection sensor) 3 arranged in the image forming apparatus main body 51 to detect a sheet of recording paper P at a position upstream relative to the delivery port 54 along the delivery route and output a signal for the detection, and a sheet delivery drive directing circuit 4 for outputting a drive directing signal to the sheet delivery mechanism 2 upon receiving the signal output from the recording paper detection sensor 3.

The frame 1 has a profile of a laterally oblong box having a horizontal dimension corresponding to the length of a sheet of recording paper P as viewed rectangularly relative to the direction along which the sheet of recording paper P is delivered. It is arranged along the longitudinal direction of the delivery port vis-a-vis the wall defining the delivery space 53 at a position outside the wall in the delivery space 53 of the middle stage of the image forming apparatus main body 51 and removably fitted to the wall by a fitting means (not shown). The frame 1 is provided at the rear side thereof abutting the wall of the image forming apparatus main body 51 with a horizontally extending posterior delivery port 11 located vis-a-vis the delivery port 54 and at the front side thereof with an anterior delivery port 12 located at a level higher than and extending in parallel with the posterior delivery port 11. The anterior delivery port 12 is open at the opposite extremities so that a sheet of recording paper P may be discharged laterally therethrough as will be discussed hereinafter. An actuator 13 is arranged outside the front wall of the frame 1 and is linked to a sensor (not shown) for detecting the load of the recording paper P which is discharged from the anterior delivery port 12 and discharged to a delivery tray 14 to be discussed hereinafter and a delivery tray 14 is arranged at a lower position outside the front wall of the frame 1 for receiving the sheets of recording paper P discharged from the anterior delivery port 12 and holding them as a stack.

Now, the sheet delivery mechanism 2 arranged in the frame 1 will be described in detail. The frame 1 is provided in the inside thereof with guide members 15, 16 for guiding and transferring each sheet of paper from the posterior delivery port 11 at the rear side of the frame 1 to the anterior delivery port 12 at the front side thereof. Additionally, a pair of discharge rollers 17A, 17B are arranged at the center of the anterior delivery port 12 in the frame 1. The paired discharge rollers 17A, 17B are located at a position upstream relative to and extending in parallel with the anterior delivery port 12 in the frame 1. One of the pair of discharge rollers 17A, 17B, say the discharge roller 17A, is the driving roller whereas the other discharge roller, or the discharge roller 17B is the driven roller. The driving roller 17A is linked to an electric motor 18 arranged in the middle stage of the image forming apparatus main body 51 by way of a gear 19 also arranged in the middle stage of the image forming apparatus main body 51 and a group of gears 20 arranged in the frame 1 so that the rotary motion of the electric motor 18 may be transmitted to the driving roller 17A to rotate the latter. As the frame 1 is fitted to the middle stage of the image forming apparatus main body 51, the first gear of the group of gears 20 arranged in the frame 1 engages with the gear 19 arranged in the middle stage of the image forming apparatus main body 51 so that the rotary motion of the electric motor 18 is transmitted to the driving roller 17A.

Additionally, a pair of transversal delivery rollers 21A, 21B are arranged at a position upstream relative to a longitudinal end of the anterior delivery port 12 of the frame 1 along the recording paper delivery route. The axes of rotation of the paired transversal delivery rollers 21A, 21B are perpendicular to those of the discharge rollers 17A, 17B (and the anterior delivery port 12). One of the pair of transversal discharge rollers 21A, 21B, say the transversal discharge roller 21A, is the driving roller whereas the other transversal discharge roller, or the transversal discharge roller 21B is the driven roller. The driving roller 21A is linked to an electric motor 22 arranged in the frame 1 for transversal delivery by way of a gear (not shown).

The recording paper detection sensor 3 is arranged on the recording paper delivery route between the fixing mechanism 60 and the delivery rollers 61A, 61B in the middle stage of the image forming apparatus main body 51. The sensor 3 is used to detect a jammed sheet of recording paper in the image forming apparatus main body 51 and/or control the operation of driving each of the mechanisms arranged in the image forming apparatus main body 51. The recording paper detection sensor 3 typically comprises a light source for emitting rays of light, a light receiving member for receiving the rays of light emitted from the light source and converting them into an electric signal and a lever 3a adapted to swing between a non-detecting position located off the light path between the light source and the light receiving member and a detecting position where it blocks the rays of light being transmitted from the light source to the light receiving member. The lever 3a is held to the non-detecting position when there is no sheet of recording paper P being transferred along the delivery route R. However, as a sheet of recording paper P is transferred along the delivery route R, the lever 3a is pushed by the sheet of recording paper P to move from the non-detecting position to the detecting-position and block the rays of light emitted from the light source so that the light receiving member outputs a signal corresponding to this condition. More specifically, the recording paper detection sensor 3 outputs an H level signal when it is moved to the detecting position and an L level signal when it is moved to the non-detecting position.

As the front end of the sheet of recording paper P pushes the lever 3a to swing it from the non-detecting position to the detecting position, it is detected that the front end of the sheet of recording paper P passes by the sensor 3. Similarly, as the rear end of the sheet of recording paper P leaves the lever 3a to swing it from the detecting position back to the non-detecting position, it is detected that the rear end of sheet of recording paper P passes by the sensor 3.

The detection signal output from the recording paper detection sensor 3 is transmitted to control circuit 62 arranged in the image forming apparatus main body 51 and used for the purpose of detecting a jammed sheet of recording paper in the image forming apparatus main body 51 and/or controlling the operation of driving each of the mechanisms arranged in the image forming apparatus main body 51. Additionally, the control circuit 62 outputs a delivery drive directing signal b to the delivery drive directing circuit 4 arranged in the image forming apparatus main body 51 for driving the sheet delivery mechanism 2 on the basis of the detection signal a input to the control circuit 62.

The delivery drive directing circuit 4 is arranged in the middle stage of the image forming apparatus main body 51. Upon receiving a detection signal, e.g., a detection signal from the recording paper detection sensor 3 indicating that the rear end of a sheet of recording paper P has passed by the sensor 3 arranged in the image forming apparatus main body 51, the delivery drive directing circuit 4 outputs a signal directing an operation of driving the delivery rollers 17A, 17B or the transversal delivery rollers 21A, 21B of the sheet delivery mechanism 2. The delivery drive directing circuit 4 is incorporated in the main body control circuit 62 for controlling the operation of driving each of the mechanisms mounted in the image forming apparatus main body 51. The signal c output from the delivery drive directing circuit 4 is transmitted to the drive circuit 23 arranged in the frame 1. The drive circuit 23 is adapted to output a direct drive signal to the electric motor 22 for transversal delivery arranged in the frame 1 or a signal d to the control circuit 62 for driving the electric motor 18 for delivery upon receiving a directing signal from the delivery drive directing circuit 4. The control circuit 62 is connected to a drive circuit 71, and the drive circuit 71 drives the electric motor 18 for driving the delivery rollers 17A, 17B.

Now, the operation of the delivery device having the above described configuration will be described below.

In the image forming apparatus main body 11, the toner image formed on the sheet of recording paper P by the image forming mechanism 59 is fixed as the sheet of recording paper P vertically passes through the fixing mechanism 60. Then, the sheet of recording paper P is guided by a guide member (not shown) into a direction perpendicular to the direction in which it passes through the fixing mechanism 60 and subsequently made to pass horizontally through the pair of delivery rollers 61A, 61B before it is delivered to the outside by way of the horizontal delivery port 54 formed in the wall of the middle stage of the image forming apparatus main body 51.

As for the recording paper sensor 3 that is arranged along the recording paper delivery route between the fixing mechanism 60 and the delivery rollers 61A, 61B, the lever 3a thereof is located in the non-detecting position as long as there is no sheet of recording paper P being transported along the delivery route. However, if a sheet of recording paper P is transported along the delivery route, the lever 3a is pushed by the front end of the sheet of recording paper P to move from the non-detecting position to the detecting position and block the rays of light emitted from the light source toward the light receiving member. As a result, the light receiving member detects that the front end of the sheet of recording paper P has reached the recording paper detection sensor 3. Then, the light receiving member outputs a detection signal to the control circuit 62 and also to the delivery drive directing circuit 4.

Upon receiving the detection signal from the light receiving member, the control circuit 62 outputs a signal for controlling the operation of driving each of the mechanisms arranged in the image forming apparatus main body 51. For instance, the control circuit 62 may output a signal indicating that the front end of a sheet of recording paper P has passed by the sensor so that the delivery rollers 61A, 61B need to be driven. As a result, the delivery rollers 61A, 61B are rotated by an electric motor (not shown) in the direction indicated by the arrow and discharge the sheet of recording paper P through the delivery port 54.

The sheet of recording paper discharged from the delivery port 54 then enters the inside of the frame 1 through the posterior delivery port 11 and is guided by the guide members 15, 16 to the delivery rollers 17A, 17B. Upon receiving a signal from the recording paper detection sensor 3, the delivery drive directing circuit 4 outputs a drive directing signal to the drive circuit 23 arranged in the frame 1 when the first set time T1 has passed for the period from the time of receiving the signal to the time immediately before the front end of the sheet of recording paper P gets to the delivery rollers 17A, 17B. Upon receiving the drive signal, the drive circuit 23 outputs a corresponding signal to the control circuit 62, which by turn drives the electric motor 18 for delivery in response to the signal it receives. The rotary motion of the electric motor 18 is transmitted to the delivery rollers 17A, 17B by way of the gear 19 and the group of gears 20 so that the delivery rollers 17A, 17B are driven to rotate. As a result, the sheet of recording paper P discharged from the image forming apparatus main body 51 is transferred by the rotating delivery rollers 17A, 17B to the outside of the frame 1 through the anterior delivery port 12.

The light receiving member keeps on outputting an H level detection signal as long as the lever 3a of the recording paper detection sensor 3 is pushed away by the sheet of recording paper P being transferred along the delivery route. However, as the rear end of the sheet of recording paper P passes by the lever 3a, the lever 3a is moved from the detecting position back to the non-detecting position so that the rays of light emitted from the light source are received by the light receiving member. Then, the detection signal of the light receiving member goes to L level.

The delivery drive directing circuit 4 outputs a drive directing signal c for driving the electric motor 22 for transversal delivery to the drive circuit 23 in the frame 1 when the second set time T2 has passed for a period from the time of detection of the rear end of a sheet of recording paper P passing by the recording paper detection sensor 3. Then, the drive circuit 23 starts driving the electric motor 22 for transversal delivery immediately before the rear end of the sheet of recording paper P leaves the delivery rollers 17A, 17B. Furthermore, the delivery drive directing circuit 4 outputs a signal d when the third set time T3 has passed for a period from the time of outputting the drive signal c. Upon receiving the signal d, the control circuit 62 outputs a stop signal to the drive circuit 71. As a result, the operation of driving the electric motor 18 for delivery is stopped.

Thus, the sheet of recording paper P is transported by the transversal delivery rollers 21A, 21B in a direction (offset) rectangular relative to the delivery route of the delivery rollers 17A, 17B.

Thus, with a delivery device according to the invention, the sheet detection sensor 3 arranged in the main body 51 of the image forming apparatus for detecting a sheet of recording paper can be used as a drive sensor for driving the sheet delivery mechanism 2 by combining the sheet detecting sensor 3 arranged in the main body 51 of the image forming apparatus and the delivery drive directing circuit 4 for directing the sheet delivery mechanism 2 to be driven on the basis of the signal output from the sheet detecting sensor 3. With such an arrangement, it is no longer necessary to provide the frame 1 of the delivery device with a drive sensor and hence a delivery device according to the invention comprises a reduced number of components and hence has a compact frame 1 for housing them.

Additionally, the frame 1 of the delivery device can be made to be more compact by removing the drive circuit 23 from the frame 1 of the delivery device and installing it within the image forming apparatus main body 51. Then, the drive circuit 23 may be commonly used by some other delivery device that may alternatively be fitted to the image forming apparatus main body 51.

The present invention is by no means limited to the above described embodiment, which may be modified and/or altered in various different ways without departing from the scope of the invention. For instance, a delivery device according to the invention may be provided with a mechanism for sorting the sheets of recording paper discharged through the delivery port of the image forming apparatus main body into two vertically arranged trays. In other words, the transversal delivery rollers 21A, 21B may be replaced by a pair of vertical delivery rollers for sorting sheets of recording paper into two vertically arranged trays.

A delivery device according to the invention is applicable not only to an arrangement for delivery sheets of recording paper from the main body of an image forming apparatus but also to an arrangement for delivering an original.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A delivery device comprising:
a frame to be fitted to the main body of an image forming apparatus carrying an image recording mechanism mounted therein and provided with a delivery port and a delivery mechanism for delivering sheets of recording paper along a delivery route to the outside through the delivery port;
a sheet delivery mechanism arranged in the frame for sending out the sheets of recording paper discharged from the delivery port of the main body of the image forming apparatus in a predetermined direction;
a sheet detection sensor arranged along the sheet transfer path in the main body of the image forming apparatus for detecting a sheet of recording paper; and
a delivery drive directing circuit for directing the sheet delivery mechanism to be driven on the basis of the detection output of the sheet detection sensor.

2. The delivery device according to claim 1, wherein
said delivery drive directing circuit is arranged in the main body of the image forming apparatus.

3. The delivery device according to claim 1, wherein
said frame is removably fitted into a delivery space arranged in said image forming apparatus.

4. The delivery device according to claim 1, wherein
said sheet delivery mechanism includes a first pair of rollers for transferring the sheet of recording paper discharged through the delivery port of the main body of the image forming apparatus along a delivery route and a second pair of rollers for transferring the sheet of recording paper discharged through the delivery port of the main body of the image forming apparatus along a route perpendicular to said delivery route.

5. The delivery device according to claim 4, wherein
said first pair of rollers are driven by a first motor arranged in the main body of the image forming apparatus and said second pair of rollers are driven by a second motor arranged in said frame.

6. The delivery device according to claim 5, wherein
said first motor is driven by a first drive circuit and said second motor is driven by a second drive circuit;
said first motor being adapted to start to be driven by said first drive circuit after an elapse of the first set time since the detection of the front end of a sheet of recording paper by said sheet detection sensor;
said second motor being adapted to start to be driven by said second drive circuit after an elapse of the second set time since the detection of the rear end of the sheet of recording paper by said sheet detection sensor.

7. The delivery device according to claim 6, wherein
the operation of driving the first motor by said first drive circuit is stopped after the start of the operation of driving the second motor by said second drive circuit.

8. The delivery device according to claim 6, wherein
said second drive circuit is arranged in the main body of the image forming apparatus.

9. The delivery device according to claim 4, wherein
said second pair of rollers are transversal delivery rollers.

10. The delivery device according to claim 4, wherein
said second pair of rollers are vertical delivery rollers.
